(19) United States
(12) Patent Application Publication
(10) Pub. No.: US 2010/0205310 A1
(43) Pub. Date: Aug. 12, 2010

(54) SYSTEM AND METHOD FOR DYNAMICALLY OPTIMIZING TCP WINDOW SIZE

(76) Inventors: Yaniv Altshuler, Haifa (IL); Eran Segal, Tel Aviv (IL); Sagi Ben-Moshe, Kiryat Bialik (IL)

Correspondence Address: DR. D. GRAESER LTD., 9003 FLORIN WAY, UPPER MARLBORO, MD, 20772, US

(21) Appl. No.: 12/369,756

(22) Filed: Feb. 12, 2009

(51) Int. Cl. G06F 15/173

(52) U.S. Cl. 709/228

(57) ABSTRACT

System and method for optimizing TCP window size in operating systems.

### FIELD OF THE INVENTION

The present invention relates to a system and a method for dynamically optimizing TCP window size and in particular for optimizing the size according to one or more specific session parameters.

### BACKGROUND OF THE INVENTION

The Transmission Control Protocol (TCP) is one of the core protocols of the Internet protocol suite. Whereas IP handles lower-level transmissions from computer to computer as a message makes its way across the Internet, TCP operates at a higher level, concerned only with the two end systems, for example a Web browser and another Web server. In particular, TCP provides reliable in-order delivery of a stream of bytes from one program on one computer to another program on another computer. Besides the Web, other common applications of TCP include, for example, e-mail and file transfer. Among its management tasks, TCP controls message size, the rate at which messages are exchanged, and network traffic congestion. TCP provides a communication service at an intermediate level between an application program and the Internet Protocol (IP). That is, when an application programmer desires to send a large chunk of data across the Internet using IP, instead of breaking the data into IP-sized pieces and issuing a series of IP requests, the programmer can issue a single request to TCP and let TCP handle the IP details.

The IP protocol operates by exchanging segments of data called packets. A packet is a sequence of bytes and consists of a header followed by a body. Due to network congestion, traffic load balancing, or other unpredictable network behavior, IP packets can be lost or delivered out of order. TCP detects these problems, requests retransmission of lost packets, rearranges out-of-order packets, and even helps minimize network congestion to reduce the occurrence of the other problems. Thus, TCP greatly simplifies the application programmer's network communication task.

The TCP protocol features many parameters. One important parameter is the window size. The TCP window size field on the receiving host controls the flow of data in the connection process and reflects the size of the received buffer on the receiving host. The TCP window size on the sending host reflects the size of the buffer on the sending host. Operating systems such as, for example, Microsoft Windows, permit the TCP window size to be configured. The actual TCP window size (or buffer size) of each session is the minimal number of the operating system configured parameter for the sending buffer size, the receiving buffer size and the CWND (Congestion window) value defined by the TCP protocol which is mainly determined by the bandwidth and the congestion of the network. The actual TCP window size may be defined during handshake and periodically throughout the session.

The conditions under which an application will be executed are not known prior to configuration (for example, the application can use a Windows XP with 1 MB/96 KB internet connection and 256 MB RAM, or it can use 10 MB/1 MB internet connection with 2 GB RAM; it can even be connected to more than one server, each configured with a different window size. An example on an application connected to more than one server is the use of any type of web browser software.

The static configuration does not provide optimal setting This configuration can cause performance problem, since the connection to a slower server might be congested, while the connection to the faster server might not utilize the whole available bandwidth because of the small operating system buffer size.

### SUMMARY OF THE INVENTION

There is an unmet need for, and it would be highly useful to have, a method for dynamically adjusting the TCP window size per each open session. There is also an unmet need and it would be highly useful to take into consideration parameters such as the server and the actual bandwidth while adjusting the window size.

The present invention overcomes the deficiencies of the background art by creating a new abstract layer between the socket layer and the user application layer, belonging to the classic seven layers model, or alternatively, by adding more functionality to the socket layer. This new layer is responsible for efficiently and dynamically selecting the operating system TCP buffer size and the TCP receiving window size for each connection. The new layer preferably selects the operating system TCP buffer window size, using the local connection properties and the properties of the destination of the current connection (a remote server). The actual TCP window transmission efficiency, which is also affected by the congestion variable CWND, is optionally optimized as a result of optimizing the TCP window size.

Optimization is preferably done automatically and without requiring any increase, or at the most a slight increase, in the handshake time during connection time.

The application preferably features a server, which is preferably located at the internet provider site. The server preferably calculates the optimum TCP window size, which should be opened for transmission of data between applications on different servers such as between web servers (or other internet point of presence)

The TCP window size is calculated by preferably measuring the local properties like connection speed, memory and the remote properties of the destination like ping time (RTT—Round Trip Time) and the data arriving from the application server. For example, the server can optionally calculate the optimum TCP window size which should be opened between the server's application and a remote content provider or service provider server; for example and without limitation, such a remote server may optionally support an Internet “portal” application, including but not limited to MSN®, Yahoo!® and the like. The optimal window sizes and optionally other parameters related to the opened session are preferably kept in the database. These parameters are periodically updated to reflect changes in bandwidth and the like. Whenever a user wishes to open a TCP session, the application, resides in user's computer, chooses between calculating locally the TCP window size, receiving the TCP window size from the local cache, requesting the TCP window size from the application server or a combination thereof. For a request from the application server, the application server returns the parameter, provided that this parameter already exists in database. In the case that the parameter does not exist, the application server preferably calculates this size. In both cases, the application server returns the result to user and optionally saves the result in database for future requests. The returned parameter is optionally caches in the local computer for future use. The local application sets the TCP window of the current session according to the calculated optimized value.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and memory storage, and/or the ability to execute one or more instructions may be described as a computer, including but not limited to a PC (personal computer), UMPC (ultra-mobile PC), a server, a minicomputer, a cellular telephone, a smart phone, a PDA (personal data assistant), a pager, TV decoder, VOD (video on demand) recorder, game console, digital music or other digital media player, ATM (machine for dispensing cash), POS credit card terminal (point of sale), electronic cash register, slot machines and gambling related machines. Any two or more of such devices in communication with each other, and/or any computer in communication with any other computer may optionally comprise a “computer network”.

Although the present invention is described with regard to a “network”, it should be noted that the protocol can be used by optionally any network, such as enterprise network, LAN, MAN, WAN or any proprietary networks.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1 is an exemplary diagram of the system.

FIG. 2 describes an exemplary scenario for calculating the optimal window size according to one embodiment of the present invention.

FIG. 3 is a diagram describing the differences between the old protocol stack and the new protocol stack according to some embodiments of the present invention.

### DESCRIPTION OF THE PREFERRED EMBODIMENTS

The principles and operation of the present invention may be better understood with reference to the drawings and the accompanying description.

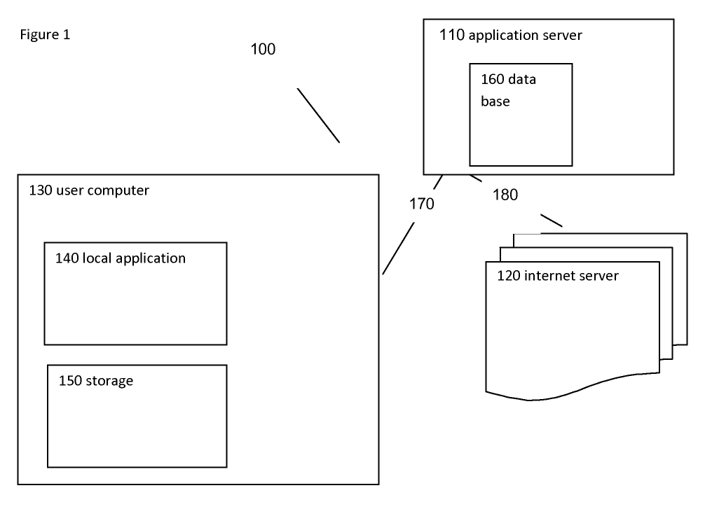

Referring now to the drawings, FIG. 1 is an exemplary diagram of the system according to some embodiments of the present invention. System 100 features an application server 110 which is preferably located at the internet site. Server 110 preferably calculates the optimum TCP window size which should be used between server 110 and internet server 120. Internet server 120 is an example herein of a target server located in a network, which is preferably the internet or the intranet, which may engage in a session with a device (described in greater detail below for the purposes of illustration only as a user computer 130). Calculation is optionally and preferably performed for a plurality of popular internet content provider servers. Communication between application server 110 and internet provider server 120 is preferably performed through a communication channel 180. Server 110 preferably keeps the optimal window size, as well as other related parameters with regard to opening a new session, for future use. Parameters are preferably kept in database 160, which optionally resides in application server 110 or, alternatively, can reside in another computer or device (not shown). The application server 110 preferably and periodically updates the TCP window sizes that are saved, regardless of the location of storage. Preferably the window size of more popular internet provider sites or servers is updated more frequently.

User computer 130 preferably communicates with application server 110 via communication channel 170. Communication between user computer 130 and application server 110 is performed, optionally through a local user application 140, whenever the user wishes to open a session with internet provider server 120 or according to periodic updates, which are preferably preset. Communication between user computer 130 and application server 110 includes retrieval of the optimal TCP window size for the current session; such communication may also optionally occur when local user application 140 determines that better results may be obtained through retrieval of information from application server 110. The retrieved data regarding window size is preferably stored at user computer 130, for example in a storage 150.

Communication channels 170 and 180 may optionally be wired or wireless. For example, communication channels 170 and/or 180 may optionally comprise a wireless packet-data network such as GPRS, EDGE, UMTS (WCDMA), EVDO, WiFi, etc. Preferably communication is based upon IP (Internet Protocol). User computer 130 can optionally be any other media platform or device, for example including but not limited to a computer monitor and/or other computer display, television, PDA, iPod™, MP3 player, pager, mobile or wireless or cellular telephone, smart phone or the like, on which the related web pages are displayed.

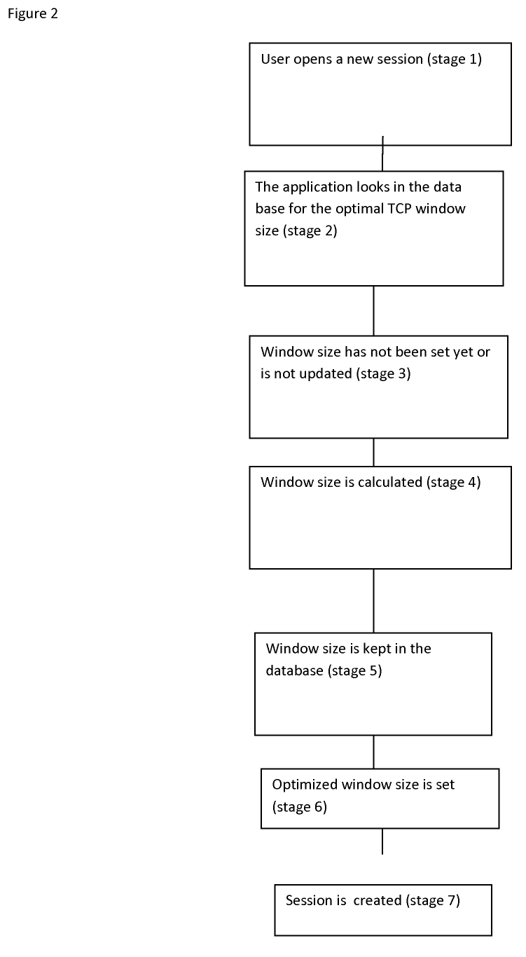

FIG. 2 describes an exemplary scenario for calculating the optimal window size according to one embodiment of the present invention. In stage 1 of the drawing, the user opens a new TCP connection. In stage 2 the application looks in the database for the optimal TCP window size. In stage 3, the application finds out that window size has not been set yet or is not updated and thus, has to be calculated. In stage 4, the TCP window (buffer) size is calculated by preferably measuring the local properties like connection speed, and memory and the remote properties of the destination like ping time (RTT—Round Trip Time) and the data sent from the application server. The connection to the application server may be already open or alternatively may optionally be opened only to obtain information regarding the desired parameters. In stage 5, the calculated size is preferably kept in the database. In stage 6, the one or more optimized parameters of the TCP session are set. In stage 7, the session is created.

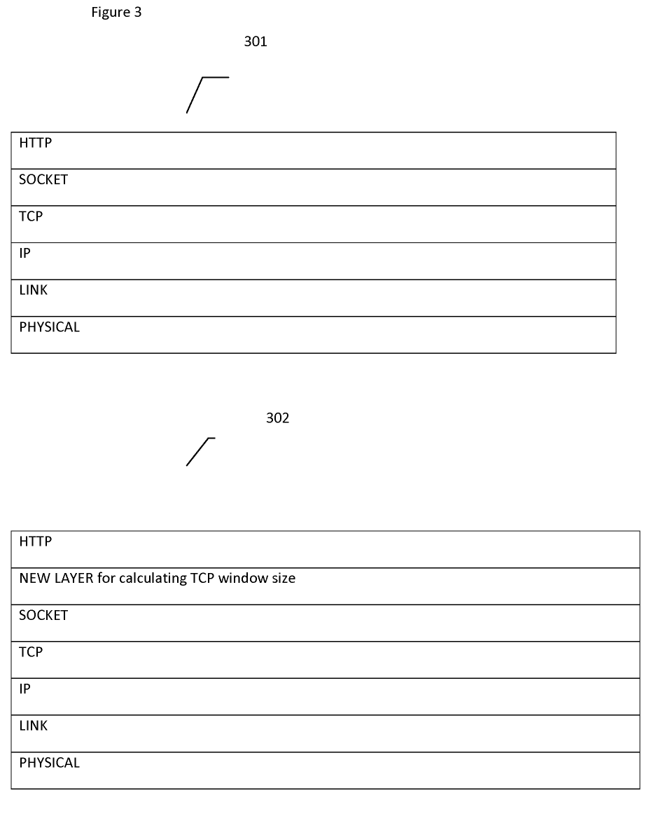

FIG. 3 is a diagram describing the difference between the old protocol stack and the new protocol stack for TCP. The old protocol has a protocol stack, shown as stack 301. The new protocol stack 302 features a new layer, not present in stack 301, for calculating the TCP window size, which interfaces between socket layer and HTTP layer. The new layer may optionally be inside the existing socket layer.

While the invention has been described with respect to a limited number of embodiments, it will be appreciated that many variations, modifications and other applications of the invention may be made.

What is claimed is:

1. A method for dynamically adjusting TCP window size for transmitting TCP packets from a computer to a server, comprising:
a. Detecting at least one connection parameter between said computer and said server; and
b. Calculating said operating system TCP window size based on said at least one connection parameter.

2. The method of claim 1 further comprising saving said result in a database.

3. The method of claim 1, wherein said calculation is done as a result of a request from a device, upon opening a connection between said device and a server of content or service provider and wherein said parameter does not exist in the database.

4. The method of claim 1, wherein said parameter is returned to said device.

5. The method of claim 1, wherein said connection parameters comprise one or more of destination and bandwidth parameters.

6. The method of claim 1 wherein said detecting said at least one connection parameter comprises retrieving said at least one connection parameter from a remote server.

7. The method of claim 1, wherein said detecting said at least one parameter comprises retrieving said TCP window size from a remote server.

8. The method of claim 1 wherein said TCP window size returned from said server is saved in a local cache.

9. The method of claim 1 wherein said parameter saved in the server's database or in the local cache is used for at least one subsequent session.

10. A system for calculating operating system TCP window size, comprising:
a. A target server;
b. A device for engaging in a session with said target server; and
c. An application server, wherein said application server calculates optimized TCP window size for at least one session between said device and said target server;
wherein said device queries said application server for optimized TCP window size.

11. The system of claim 10, further comprising a database, wherein said database stores at least said optimized TCP window size.

12. The system of claim 11, wherein said database is located at said application server.

13. The system of claim 10, wherein said target server comprises one or more of a content provider server or a service provider server.

14. The system of claim 10 wherein said device further comprises a local application for handling communication between said device and said application server.

15. The system of claim 10, wherein said application server and said device communicate through a network.

16. The system of claim 15, wherein said network comprises a plurality of networks, wherein each network can be wireless and/or fixed.

17. The system of claim 10, wherein said application server and said target communicate through a network.

18. The system of claim 17, wherein said network comprises a plurality of networks, wherein each network can be wireless and/or fixed.
